(19) United States
(12) Patent Application Publication
(10) Pub. No.: US 2020/0164496 A1
(43) Pub. Date: May 28, 2020

(54) ELECTRONIC WRENCH AND PROMPTING METHOD OF ELECTRONIC WRENCH

(71) Applicant: KABO TOOL COMPANY, Taichung City (TW)

(72) Inventor: Chih-Ching HSIEH, Taichung City (TW)

(21) Appl. No.: 16/679,330

(22) Filed: Nov. 11, 2019

(30) Foreign Application Priority Data
Nov. 22, 2018 (TW) 107141731

(51) Int. Cl. B25B 23/142

(52) U.S. Cl. CPC B25B 23/1425; B25B 13/46

(57) ABSTRACT

An electronic wrench includes a base body, at least one sensing element, a processor and at least one prompting unit. The base body includes a working head, and the sensing element is disposed at the base body to detect a working status of the working head so as to provide a sensing signal. The sensing signal includes at least one sensing value. The processor is electrically connected to the sensing element, and the processor includes at least one prompting lower limit value. The prompting unit is electrically connected to the processor and provides a working status prompt. When the sensing value is less than the prompting lower limit value or the sensing value is equal to the prompting lower limit value, the working status prompt is a first nonnumeric prompt.

### RELATED APPLICATIONS

This application claims priority to Taiwan Application Serial Number 107141731, filed Nov. 22, 2018, which is herein incorporated by reference.

### BACKGROUND

### Technical Field

The present disclosure relates to an electronic wrench. More particularly, the present disclosure relates to an electronic wrench which provides a working status prompt to a user at an unguaranteed range of precision.

### Description of Related Art

Most of conventional electronic wrenches have torque detecting functions and angle detecting functions. When a torque value of the electronic wrench is greater than a torque preset value, or an angle value of the electronic wrench is greater than an angle preset value, the electronic wrench can provide an alarm. However, because of a legislation, an error value of a detecting value shows by a display of the electronic wrench should be less than 2%, otherwise the electronic wrench cannot shows the torque value or the angle value by the display of the electronic wrench. When the electronic wrench working at an unguaranteed range of precision, the electronic wrench cannot provide any prompt for a user. Therefore, the user cannot determine a working status of the electronic wrench.

Hence, the way to provide the working status of the electronic wrench and fit the legislation when the electronic wrench working at unguaranteed range of precision is important.

### SUMMARY

According to one aspect of the present disclosure, an electronic wrench includes a base body, at least one sensing element, a processor and at least one prompting unit. The base body includes a working head, and the at least one sensing element is disposed at the base body to detect a working status of the working head so as to provide a sensing signal. The sensing signal includes at least one sensing value. The processor is electrically connected to the at least one sensing element, and the processor includes at least one prompting lower limit value. The at least one prompting unit is electrically connected to the processor and provides a working status prompt. When the at least one sensing value is less than or equal to the at least one prompting lower limit value, the working status prompt is a first nonnumeric prompt.

According to another aspect of the present disclosure, a prompting method of an electronic wrench includes configuring a working head of an electronic wrench to be applied on a workpiece; configuring at least one sensing element to detect a working status of the working head so as to provide a sensing signal, and the sensing signal includes at least one sensing value; comparing the at least one sensing value and at least one prompting lower limit value, when the at least one sensing value is less than or equal to the at least one prompting lower limit value, providing a working status prompt which is a first nonnumeric prompt.

### BRIEF DESCRIPTION OF THE DRAWINGS

The present disclosure can be more fully understood by reading the following detailed description of the embodiment, with reference made to the accompanying drawings as follows:

FIG. 1 shows a block diagram of an electronic wrench according to one embodiment of the present disclosure.

FIG. 2 shows a step flow chart of a prompting method of an electronic wrench according to another embodiment of the present disclosure.

FIG. 3 shows a schematic diagram of the first nonnumeric prompt of a liquid crystal display (LCD) of the electronic wrench according to the embodiment of FIG. 1.

### DETAILED DESCRIPTION

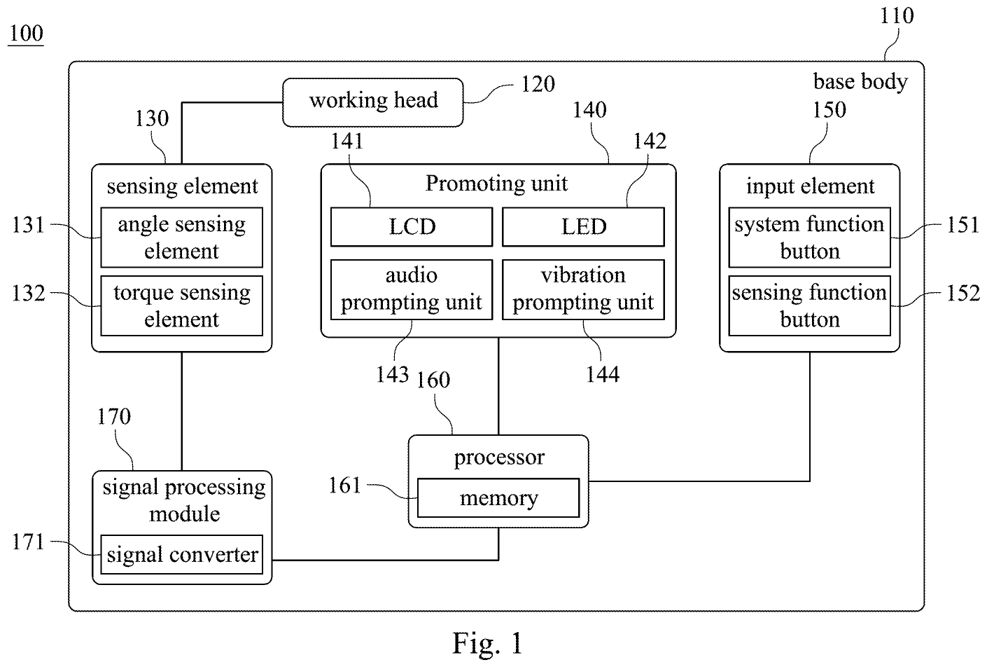

FIG. 1 shows a block diagram of an electronic wrench 100 according to one embodiment of the present disclosure. In FIG. 1, the electronic wrench 100 includes a base body 110, at least one sensing element 130, a processor 160 and at least one prompting unit 140. The sensing element 130 is disposed on the base body 110. The processor 160 is electrically connected to the sensing element 130. The prompting unit 140 is electrically connected to the processor 160.

In detail, the base body 110 includes a working head 120. The sensing element 130 is configured to detect a working status of the working head so as to provide a sensing signal. The sensing signal can include at least one sensing value. The processor 160 can include at least one prompting lower limit value, and the processor 160 can be used to compare the sensing value and the prompting lower limit value. The prompting unit 140 can be used to provide a working status prompt. The working status prompt is configured to prompt the working status of the working head 120 for a user. When the sensing value is less than the prompting lower limit value or equal to the prompting lower limit value, the working status prompt is a first nonnumeric prompt. Therefore, a front working prompt can be provided for the user via the electronic wrench 100. The working status of the working head 120 can be provided for the user via the front working prompt so as to avoid the problem that the user cannot obtain the working status of the working head 120 when the electronic wrench 100 works at an unguaranteed range of precision.

In order to provide a selecting function of the electronic wrench 100 for the user, the electronic wrench 100 can further include at least one input element 150. The input element 150 is electrically connected to the processor 160, and the input element 150 can be a physical button or a touch button. In FIG. 1, the input element 150 can include at least one system function button 151 and at least one sensing function button 152. The user can select a system function of the electronic wrench 100 via the system function button 151, such as turn on, turn off, standby or reset. A number of the system function button 151 can be single or plural. When the number of the system function button 151 is plural, the system function buttons 151 can be set according to the system function of the electronic wrench 100, such as a turn-on button (not shown), a turn-off button (not shown), a standby button (not shown) or a reset button (not shown). When the user presses the turn-off button, all of a power of the electronic wrench 100 is turned off via the processor 160 so as to transform to a turn-off status. When the user presses the standby button, a part of the power of the electronic wrench 100 is turned off via the processor 160 so as to transform to a standby status. When the user presses the reset button, a system of the electronic wrench 100 is reset via the processor 160 so as to resume to a beginning status. The user can select a sensing function of the electronic wrench 100 via the sensing function button 152, and then the hardware circuit is detected and the sensing function is performed via the electronic wrench 100, such as an angle sensing function or a torque sensing function. A number of the sensing function button 152 can be single or plural. When the number of the sensing function button 152 is plural, the sensing function buttons 152 can be set according to the sensing function of the electronic wrench 100, such as an angle sensing button (not shown) or a torque sensing button (not shown). When the user presses the angle sensing button, an angle of the working head 120 is detected via the sensing element 130 so as to produce the sensing signal. When the user presses the torque sensing button, a torque of the working head 120 is detected via the sensing element 130 so as to produce the sensing signal.

The sensing element 130 at least can include an angle sensing element 131 or a torque sensing element 132. The sensing value at least can include an angle sensing value or a torque sensing value. In the embodiment of FIG. 1, the sensing element 130 includes the angle sensing element 131 and the torque sensing element 132. That is, the angle and the torque of the working head 120 can be detected via the electronic wrench 100.

The electronic wrench 100 can further include a signal processing module 170. The signal processing module 170 is electrically connected to the processor 160 and the sensing element 130. The sensing signal produced by the sensing element 130 is received via the signal processing module 170 to perform a signal process so as to produce a processing sensing signal, and the processing sensing signal is transmitted to the processor 160. The sensing signal can be an analog sensing signal or a digital sensing signal. The signal processing module 170 can include a signal converter 171 and an amplifier (not shown). In other words, when the sensing signal is the analog sensing signal, the sensing signal can be transformed to the digital sensing signal via the signal converter 171, and then the digital sensing signal is transmitted to the processor 160, or the sensing signal can be amplified via the amplifier first, and then transformed to the digital sensing signal via the signal converter 171, and the digital sensing signal is transmitted to the processor 160.

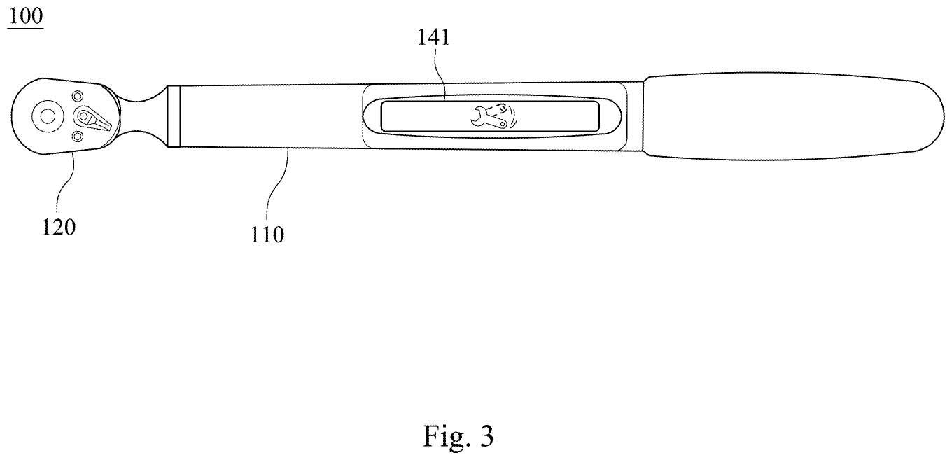

FIG. 3 shows a schematic diagram of the first nonnumeric prompt of a liquid crystal display (LCD) of the electronic wrench 100 according to the embodiment of FIG. 1. In FIG. 3, the processor 160 can further include at least one prompting upper limit value and a working value. The working value is the greatest torque value of the electronic wrench 100 or the greatest angle value of the electronic wrench 100. The prompting lower limit value can be less than or equal to 20% of the working value, or the prompting lower limit value can be set by the user. For example, the prompting lower limit value can be 20% of the working value, 10% of the working value or 5% of the working value. The prompting upper limit value can be equal to the working value or set by the user. The user can set the prompting upper limit value and the prompting lower limit value via the input element 150, such as pressing the input element 150 repeatedly. Furthermore, the processor 160 can be used to compare the sensing value and the prompting upper limit value. When the sensing value is greater than the prompting lower limit value and less than the prompting upper limit value, the working status prompt is a first numeric prompt or a second nonnumeric prompt; and when the sensing value is greater than or equal to the prompting upper limit value, the working status prompt is a second numeric prompt or a third nonnumeric prompt. The prompting unit 140 at least can include a LCD 141, a LED 142, an audio prompting unit 143 and a vibration prompting unit 144. The first numeric prompt and the second numeric prompt can be an un-flashing numeric prompt or a flashing numeric prompt by the LCD 141 so as to provide different numeric prompts to the user. The un-flashing numeric prompt the LCD 141 is displayed continuously. The flashing numeric prompt the LCD 141 is displayed flashily. The first nonnumeric prompt, the second nonnumeric prompt and the third nonnumeric prompt can be a LCD nonnumeric prompt, a lighting prompt, an audio prompt or a vibrating prompt. The lighting prompt can be an un-flashing prompt of the LED 142 or a flashing prompt of the LED 142. The lighting prompt can provide different light color or different flashing frequency by the LED 142. The audio prompt can provide different audio frequency and different volume by the audio prompting unit 143. The vibrating prompt can provide different vibrating frequency and different vibrating intensity by the vibration prompting unit 144. The user can select the working status prompt via the input element 150. In other words, a plurality of the working status prompt for user can be provided via the electronic wrench 100, and the user can select the working status prompt by himself. Moreover, the prompting upper limit value and the prompting lower limit value can be set by the user. When the working value is 100 N, and the user sets that the prompting lower limit value as 10% of the working value and the prompting upper limit value is equal to the working value, if the sensing value is less than 10 N, the user is prompted by the first nonnumeric prompt provided by the prompting unit 140. The first nonnumeric prompt can be the LCD nonnumeric prompt, such as a swinging wrench as shown in FIG. 3. When the sensing value is greater than 10 N and less than 100 N, the user is prompted by the first numeric prompt or the second nonnumeric prompt provided by the prompting unit 140. The first numeric prompt can be the un-flashing numeric prompt. The second nonnumeric prompt can be an un-flashing green lighting prompt by the LED 142. When the sensing value is greater than or equal to 100 N, the prompting unit 140 can provide the second numeric prompt or the third nonnumeric prompt. The second numeric prompt can be the flashing numeric prompt. The third nonnumeric prompt can be the vibrating prompt.

The processor 160 can further include a memory 161. The sensing value and the prompting lower limit value can be saved via the memory 161, so that the working status prompt can be still provided after work via the electronic wrench 100.

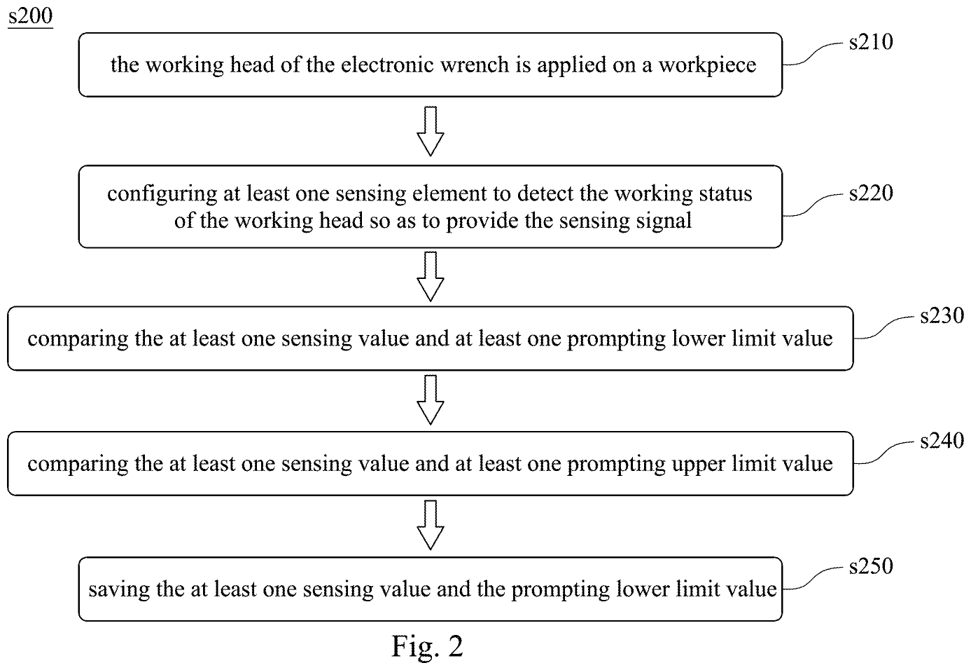

FIG. 2 shows a step flow chart of a prompting method of an electronic wrench s200 according to another embodiment of the present disclosure. The prompting method of the electronic wrench s200 can apply to the electronic wrench 100 of the embodiment of FIG. 1, but is not limited thereto. In FIG. 2, the prompting method of the electronic wrench s200 includes a plurality of steps. The step s210 is configuring the working head 120 of the electronic wrench 100 to be applied on a workpiece. The step s220 is configuring the sensing element 130 to detect the working status of the working head 120 so as to provide the sensing signal. The sensing signal includes the sensing value. The step s230 is comparing the sensing value and the prompting lower limit value. When the sensing value is less than or equal to the prompting lower limit value, providing the working status prompt, and the working status prompt is the first nonnumeric prompt. In detail, when the working head 120 of the electronic wrench 100 is applied on the workpiece, the sensing element 130 detects the working status of the working head 120 so as to produce the sensing signal, and transmitted the sensing signal to the processor 160. The sensing signal includes the sensing value. The processor 160 can include the prompting lower limit value. After the sensing signal received via the processor 160, the sensing value and the prompting lower limit value are compared via the processor 160 so as to produce a comparing result. The prompting unit 140 can produce the working status prompt according to the comparing result so as to prompt the working status of the working head 120 to the user. When the comparing result is the sensing value less than the prompting lower limit value, the first nonnumeric prompt is provided via the prompting unit 140. Therefore, the front working prompt can be provided via the electronic wrench 100 for the user so as to avoid the problem that the user cannot obtain the working status of the working head 120 when the electronic wrench 100 works at the unguaranteed range of precision.

The sensing element 130 can at least include the angle sensing element 131 or the torque sensing element 132. The sensing value can be the angle sensing value or the torque sensing value. The processor 160 can include at least two prompting lower limit value. The prompting lower limit value includes an angle prompting lower limit value and a torque prompting lower limit value. The angle prompting lower limit value and the angle sensing value can be compared or the torque prompting lower limit value and the torque sensing value can be compared via the processor 160 so as to produce the comparing result.

Furthermore, when the sensing signal is the analog sensing signal, the sensing signal can be transformed to the digital sensing signal by the signal converter 171, and transmitted to the processor 160, or the sensing signal can be amplified by the amplifier, and then transformed to the digital sensing signal by the signal converter 171, and transmitted to the processor 160.

Moreover, the prompting method of the electronic wrench s200 can be not only used to compare the sensing value and the prompting lower limit value but further include a step s240. The sensing value and the prompting upper limit value are compared via the step s240. The prompting upper limit value can be equal to the working value or set by the user, and the prompting lower limit value can be less than or equal to 20% of the working value or set by the user. In other words, the prompting lower limit value can be 20% of the working value, 10% of the working value or 5% of the working value. The working value can be the greatest torque value of the electronic wrench 100 or the greatest angle value of the electronic wrench 100. The user can set the prompting upper limit value and the prompting lower limit value by the input element 150, such as pressing the input element 150 repeatedly. When the sensing value is greater than the prompting lower limit value and less than the prompting upper limit value, the working status prompt is the first numeric prompt or the second nonnumeric prompt; when the sensing value is greater than or equal to the prompting upper limit value, the working status prompt is the second numeric prompt or the third nonnumeric prompt.

In detail, the processor 160 can further include the prompting upper limit value and the working value, so that the sensing value and the prompting upper limit value can be compared via the processor 160 so as to produce the comparing result. The different working status prompts can be provided via the prompting unit 140 according to the comparing result, so that the user can obtain the working status of the working head 120 according to the working status prompt. In order to provide the working status of the working head 120 for the user, the working status prompt can be provided via the prompting unit 140. The prompting unit 140 can be the LCD 141, the LED 142, the audio prompting unit 143 or the vibration prompting unit 144. The first numeric prompt, the second numeric prompt, the first nonnumeric prompt, the second nonnumeric prompt and the third nonnumeric prompt can be provided via the LCD 141. The first numeric prompt and the second numeric prompt can be the un-flashing numeric prompt or the flashing numeric prompt. In other words, in order to provide difference numeric prompt for the user, the un-flashing numeric prompt represents the LCD 141 is displayed continuously, or the flashing numeric prompt represents the LCD 141 is displayed flashily. The first nonnumeric prompt, the second nonnumeric prompt and the third nonnumeric prompt can be provided via the LED 142, the audio prompting unit 143 and the vibration prompting unit 144, so that the first nonnumeric prompt, the second nonnumeric prompt and the third nonnumeric prompt can be the LCD nonnumeric prompt, the lighting prompt, the audio prompt or the vibrating prompt. The lighting prompt can be an un-flashing prompt of the LED 142 or a flashing prompt of the LED 142.

The prompting method of the electronic wrench s200 can further include a step s250. The step s250 is saving the sensing value and the prompting lower limit value, so that the user can selectively let the working status prompt continue for a while.

In summary, a favorable effect of the electronic wrench 100 and the prompting method of the electronic wrench s200 is that the processor 160 can be used to provide the sensing value, the prompting upper limit value and the prompting lower limit value. When the sensing value is less than or equal to the prompting lower limit value, the working status prompt is the first nonnumeric prompt. When the sensing value is greater than the prompting lower limit value and less than the prompting upper limit value, the working status prompt is the first numeric prompt or the second nonnumeric prompt; when the sensing value is greater than or equal to the prompting upper limit value, the working status prompt is the second numeric prompt or the third nonnumeric prompt. In other words, the electronic wrench 100 can be used to provide the working status prompt so as to prompt the user according to a difference between the sensing value and the prompting upper limit value and the prompting lower limit value.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electronic wrench, comprising:
a base body comprising a working head;
at least one sensing element disposed at the base body to detect a working status of the working head so as to provide a sensing signal, wherein the sensing signal comprises at least one sensing value;
a processor electrically connected to the at least one sensing element and comprising at least one prompting lower limit value; and
at least one prompting unit electrically connected to the processor and providing a working status prompt, wherein when the at least one sensing value is less than or equal to the at least one prompting lower limit value, the working status prompt is a first nonnumeric prompt.

2. The electronic wrench of claim 1, wherein the processor further comprises a working value, wherein the at least one prompting lower limit value is less than or equal to 20% of the working value.

3. The electronic wrench of claim 1, wherein the processor further comprises at least one prompting upper limit value;
wherein when the at least one sensing value is greater than the at least one prompting lower limit value and lower than the at least one prompting upper limit value, the working status prompt is a first numeric prompt or a second nonnumeric prompt;
wherein when the at least one sensing value is greater than or equal to the at least one prompting upper limit value, the working status prompt is a second numeric prompt or a third nonnumeric prompt.

4. The electronic wrench of claim 3, wherein the at least one prompting lower limit value and the at least one prompting upper limit value are set by a user.

5. A prompting method of an electronic wrench, comprising:
configuring a working head of an electronic wrench to be applied on a workpiece;
configuring at least one sensing element to detect a working status of the working head so as to provide a sensing signal, wherein the sensing signal comprises at least one sensing value; and
comparing the at least one sensing value and at least one prompting lower limit value, wherein when the at least one sensing value is less than or equal to the at least one prompting lower limit value, providing a working status prompt which is a first nonnumeric prompt.

6. The prompting method of the electronic wrench of claim 5, further comprising:
providing a working value, wherein the at least one prompting lower limit value is less than or equal to 20% of the working value.

7. The prompting method of the electronic wrench of claim 5, further comprising:
comparing the at least one sensing value and at least one prompting upper limit value;
wherein when the at least one sensing value is greater than the at least one prompting lower limit value and less than the at least one prompting upper limit value, the working status prompt is a first numeric prompt or a second nonnumeric prompt;
wherein when the at least one sensing value is greater than or equal to the at least one prompting upper limit value, the working status prompt is a second numeric prompt or a third nonnumeric prompt.

8. The prompting method of the electronic wrench of claim 7, wherein the at least one prompting lower limit value and the at least one prompting upper limit value are set by a user.
